(19) United States
(12) Patent Application Publication
(10) Pub. No.: US 2014/0093335 A1
(43) Pub. Date: Apr. 3, 2014

(54) RAIL TRANSPORTATION MEANS USED IN BOTTLED PREPARATION MANUFACTURING PROCESS

(71) Applicant: Wei-Hua CHIANG, HSIN-CHU HSIEN (TW)

(72) Inventor: Wei-Hua CHIANG, HSIN-CHU HSIEN (TW)

(21) Appl. No.: 13/960,957

(22) Filed: Aug. 7, 2013

(30) Foreign Application Priority Data
Oct. 3, 2012 (TW) 101136455

(51) Int. Cl. B65G 49/00

(52) U.S. Cl. CPC B65G 49/00
USPC 414/222.01; 414/749.1; 414/751.1

(57) ABSTRACT

A rail transportation means used in bottled preparation manufacturing process is provided with a rail and a slide block slidably mounted on the rail. On the slide block are provided a first movable guideway, a second movable guideway, a position-switch device and a material loading-and-unloading mechanism. The rail transportation means is capable of automatically transporting feeding trays to and forth between the filling area and other relative equipments involved in the manufacturing process, such as the lyophilizer and the sealing device, without requiring manual intervention, thus allowing the bottled preparation manufacturing process to be carried out in a dust-free and sterile environment, increasing product yield and production efficiency.

### BACKGROUND OF THE INVENTION

1. Field of the Invention

The present invention relates to an automated rail transportation means, and more particularly to a rail transportation means used in bottled preparation manufacturing process.

2. Description of the Prior Art

Drug preparation, such as injection, sterile preparation, biological preparation, or cytotoxic agents, is difficult to preserved when containing moisture or water, therefore, it should be lyophilized and preserved in glass bottles, and then the glass bottles are sealed easy storage and transportation.

As shown in FIG. 1, bottled preparation manufacturing process essentially involves the steps of: filling S11, lyophilizing S12, sealing S13 and final product preservation S14. The step of filling S11 involves placing the bottles on a feeding tray, filling the bottles with drugs and plugging the bottles, and then manually transporting the bottles to a lyophilizer for lyophilizing the drug in the bottles (step 12). After that, the bottles are manually transported to a sealing machine, where the bottles are sealed with plugs and finally manually transported to a final product storage area for preservation.

It is to be noted that the abovementioned bottled preparation manufacturing process should be carried out in a sterile environment to avoid contamination, therefore, the workers have to wear clean and sterile clothes to transport the feeding trays, which not only increases manpower cost, the manual intervention in the feeding tray transportation is also likely to cause contamination, and accordingly resulting in low product yield.

The present invention has arisen to mitigate and/or obviate the afore-described disadvantages.

### SUMMARY OF THE INVENTION

The primary objective of the present invention is to provide a rail transportation means used in bottled preparation manufacturing process, which is capable of automatically transporting feeding trays to and forth between the filling area and other relative equipments involved in the manufacturing process, such as the lyophilizer and the sealing device, without requiring manual intervention, thus allowing the bottled preparation manufacturing process to be carried out in a dust-free and sterile environment, increasing product yield and production efficiency.

To achieve the above objective, a rail transportation means used in bottled preparation manufacturing process in accordance with the present invention to transport a feeding tray, comprises: a rail extending in a first direction; a slide block including a base portion slidably mounted on the rail and a control unit mounted on the base portion, the base portion being controlled by the control unit to move on the rail along the X direction; a first movable guideway including a first guideway which is mounted on the base portion of the slide block and perpendicular to the first direction, and a first power source provided at one end of the first guideway, a direction in which the first guideway moves being defined as a second direction; a second movable guideway including a second guideway which is disposed at one side of the first guideway and perpendicular to the first and second directions, a drive member connected between the first and second guideways, and a second power source disposed at one end of the second guideway, a direction along which the second guideway extends being defined as a third direction, the second guideway and the drive member being driven by the first guideway to move along the second direction, and the second guideway being driven by the second power source to move in the third direction; a material loading-and-unloading mechanism including a first picking member and a second picking member which are disposed on the second guideway in a superimposed manner, at one end of each of the first and second picking members being formed a drive portion, another end of each of the first and second picking members being provided with two inserting members to insert in a feeding tray, and the inserting members of the first and second picking members being located opposite to each other, the first and second picking members being driven by their respective power sources to move oppositely along the third direction; and a position-switch device including a third movable guideway mounted on a top of the first movable guideway and extending in the third direction, and a hook member which has a connecting portion coupled to and driven by the third movable guideway to move along the third direction, the connecting portion extending in the first direction and having two hook ends to hook the feeding tray for enabling the first and second picking members to pick up the feeding tray by inserting the inserting members into the feeding tray.

Preferably, the material loading-and-unloading mechanism is provided with a pair of clamping members, the feeding tray is correspondingly provided with a pair of clamping portions, and clamping operation of the clamping members is controlled by two pressure cylinders.

### BRIEF DESCRIPTION OF THE DRAWINGS

FIG. 1 is a flow chart of a conventional bottled preparation manufacturing process;

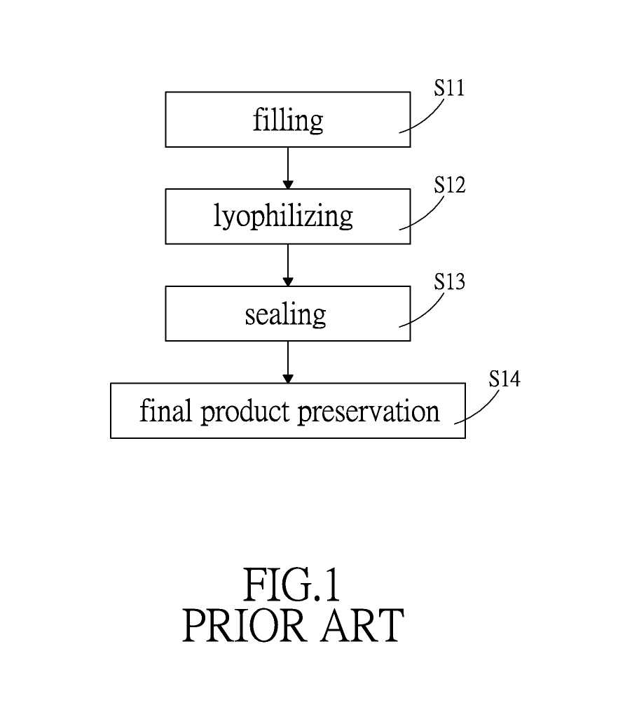

FIG. 2 is a perspective view of a rail transportation means used in bottled preparation manufacturing process in accordance with a preferred embodiment of the present invention;

FIG. 3 is a side view of the rail transportation means used in bottled preparation manufacturing process in accordance with the preferred embodiment of the present invention;

FIG. 4 is an illustrative view showing that the rail transportation means of the present invention is a stationary state;

FIG. 5 shows that the feeding tray is moved from the first picking member to the second picking member by the trail transportation means of the present invention;

FIG. 6 shows that the feeding tray is transported to the relative equipment used in the bottled preparation manufacturing process of the present invention;

FIG. 7 is an enlarged view of a part of a rail transportation means used in bottled preparation manufacturing process in accordance with another preferred embodiment of the present invention; and

FIG. 8 is another enlarged view of a part of the rail transportation means in accordance with the another preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

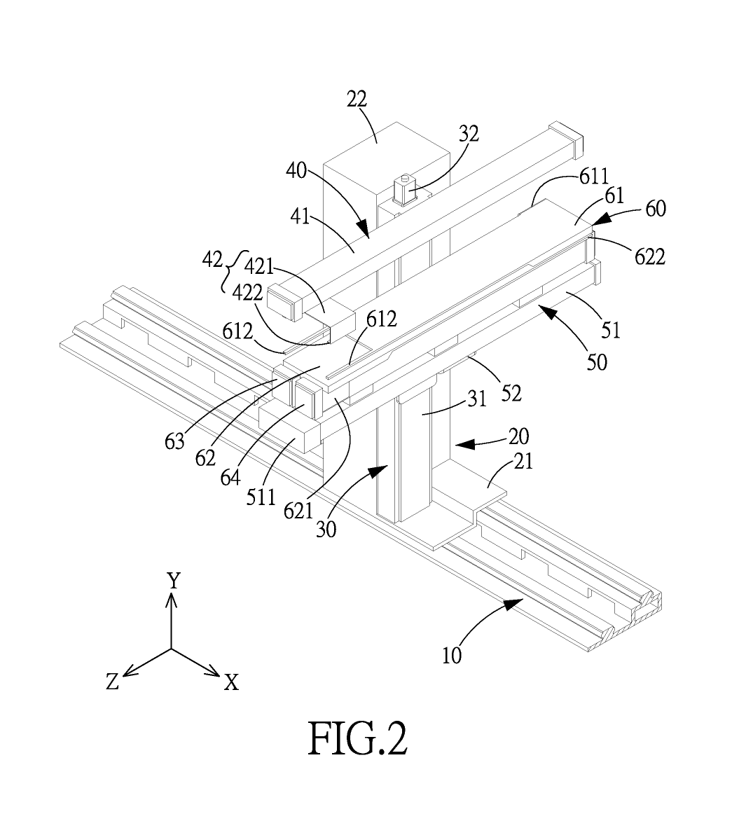

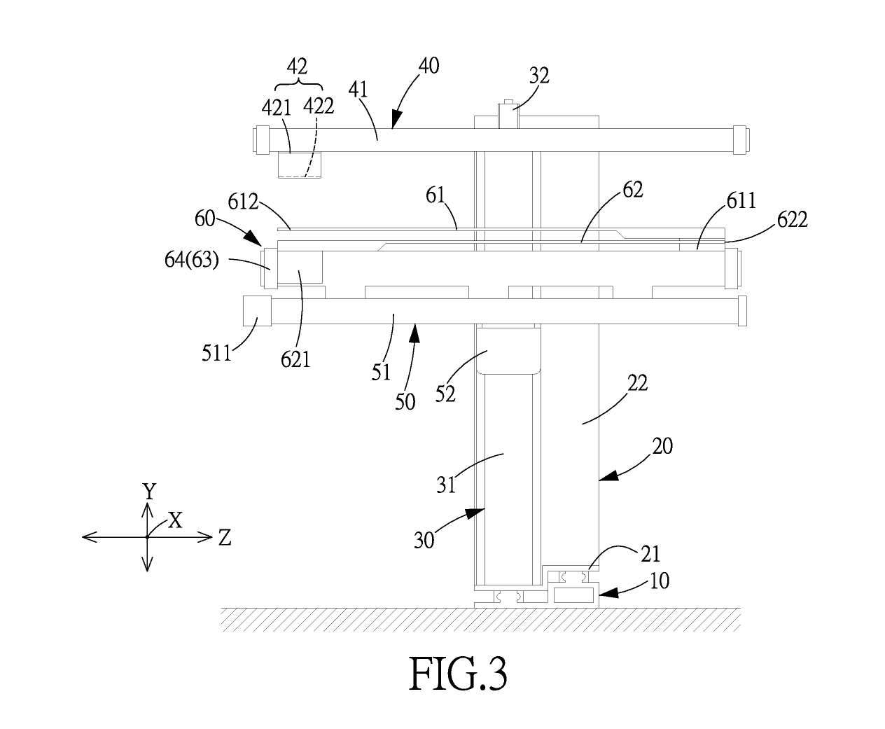

Referring to FIGS. 2 and 3, a rail transportation means used in bottled preparation manufacturing process in accordance with a preferred embodiment of the present invention is shown and essentially comprises: a rail 10 and a slide block 20 slidably mounted on the rail 10. On the slide block 20 are provided a first movable guideway 30, a second movable guideway 50, a position-switch device 40 and a material loading-and-unloading mechanism 60.

As shown in FIG. 2, the rail 10 extends in a first direction X, and the slide block 20 has a base portion 21 slidably mounted on the rail 10 and a control unit 22 mounted on the base portion 21, in such a manner that the base portion 21 is controlled by the control unit 22 to move on the rail 10 along the X direction.

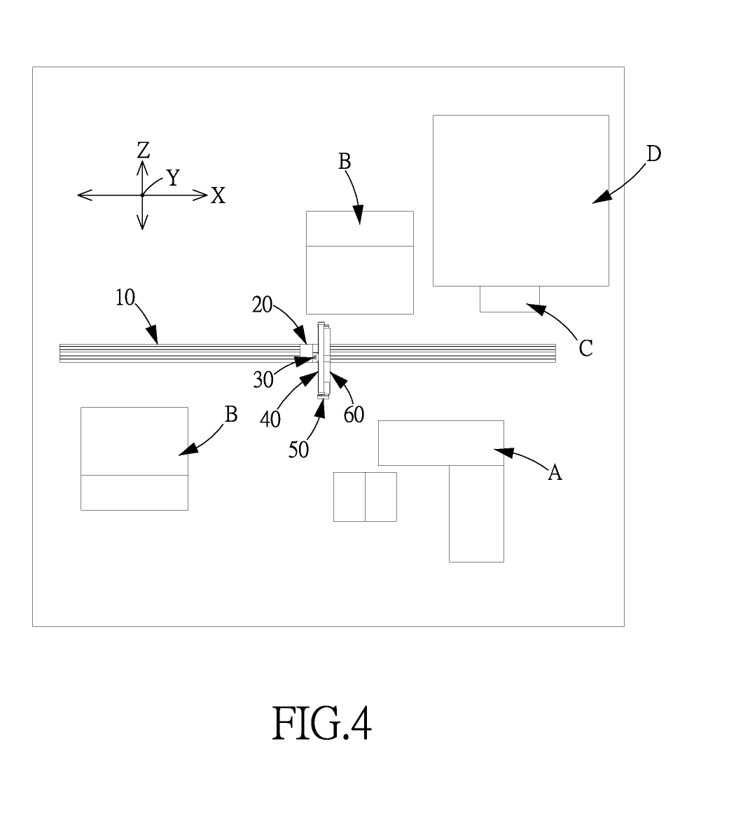

In this embodiment, as shown in FIG. 4, at one side of the rail 10 are provided a filling area A and a lyophilizer B, and at another side of the rail 10 are provided another lyophilizer B, a sealing device C and a final-product storage area D. The two lyophilizers B are located at two opposite ends of the rail 10. Or, the present invention can also be provided at an arbitrary side of the rail 10 with more than one lyophilizer B or sealing device C.

The first movable guideway 30 includes: a first guideway 31 which is mounted on the base portion 21 of the slide block 20 and perpendicular to the first direction X, and a first power source 32 provided at one end of the first guideway 31. A direction in which the first guideway 31 moves is defined as a second direction Y. The second movable guideway 50 includes: a second guideway 51 which is disposed at one side of the first guideway 31 and perpendicular to the directions X and Y, a drive member 52 connected between the first and second guideways 31, 51, and a second power source 511 disposed at one end of the second guideway 51. A direction along which the second guideway 51 extends is defined as a third direction Z. The second guideway 51 and the drive member 52 are driven by the first guideway 31 to move along the second direction Y, and the second guideway 51 can also be driven by the second power source 511 to move in the third direction Z.

The material loading-and-unloading mechanism 60 includes a first picking member 61 and a second picking member 62 which are disposed on the second guideway 51 in a superimposed manner. At one end of each of the first and second picking members 61, 62 is formed a drive portion 611, 621, another end of each of the first and second picking members 61, 62 is provided with two inserting members 612, 622 to insert in a feeding tray 70, and the inserting members 612, 622 of the first and second picking members 61, 62 are located opposite to each other. The first and second picking members 61, 62 are driven by their respective power sources 63, 64 to move oppositely along the third direction Z.

The position-switch device 40 includes: a third movable guideway 41 mounted on the top of the first movable guideway 30 and extending in the third direction Z, and a hook member 42 which has a connecting portion 421 coupled to and driven by the third movable guideway 41 to move along the third direction Z.

The connecting portion 421 extends in the first direction X and has two hook ends 422 to hook the feeding tray 70 for enabling the first and second picking members 61, 62 to pick up the feeding tray 70 by inserting the inserting members 612, 622 into the feeding tray 70.

The feeding tray 70 is provided at each of two opposite sides thereof with an upper rib 71 and a lower rib 72 which are parallel to each other and define therebetween a slot 73, so that the hook ends 422 of the hook member 42 can be inserted in the slot 73 to hook the feeding tray 70, and the inserting members 612, 622 of the first and second picking members 61, 62 of the material loading-and-unloading mechanism 60 are supported against the lower ribs 72 of the feeding tray 70.

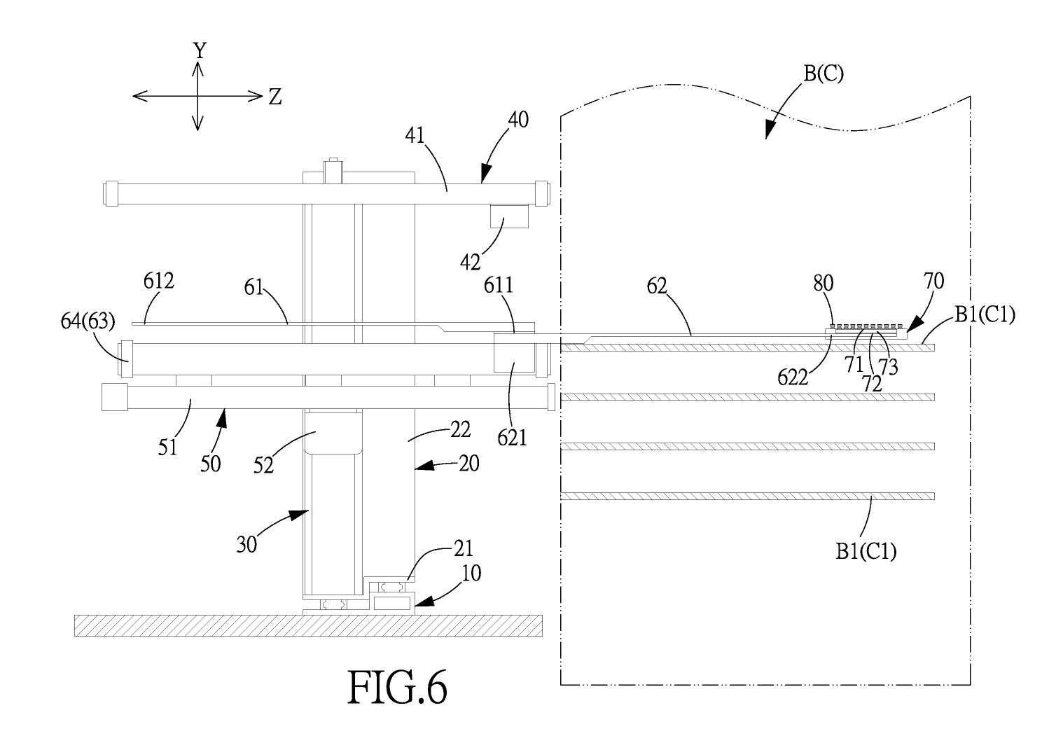

FIGS. 2-6 show how the rail transportation means of the present invention works in the bottled preparation manufacturing process. As shown in FIGS. 2 and 3, when the rail transportation means is in a stationary state, the second drive rail 50 and the material loading-and-unloading mechanism 60 are retracted in the third direction Z and located between the rail 10 and the position-switch device 40, so that the rail transportation means is retracted to its minimum size. It is to be noted that the position-switch device 40 is fixed to the first movable guideway 30, and the hook member 42 moves in the third direction Z to move the feeding tray 70 from one side of the rail 10 to the other side. The material loading-and-unloading mechanism 60 is fixed to and moves along with the second movable guideway 50 in the second or third direction Y, Z, and the first and second picking members 61, 62 are driven by their corresponding power sources 63, 64 to move oppositely in the third direction Z.

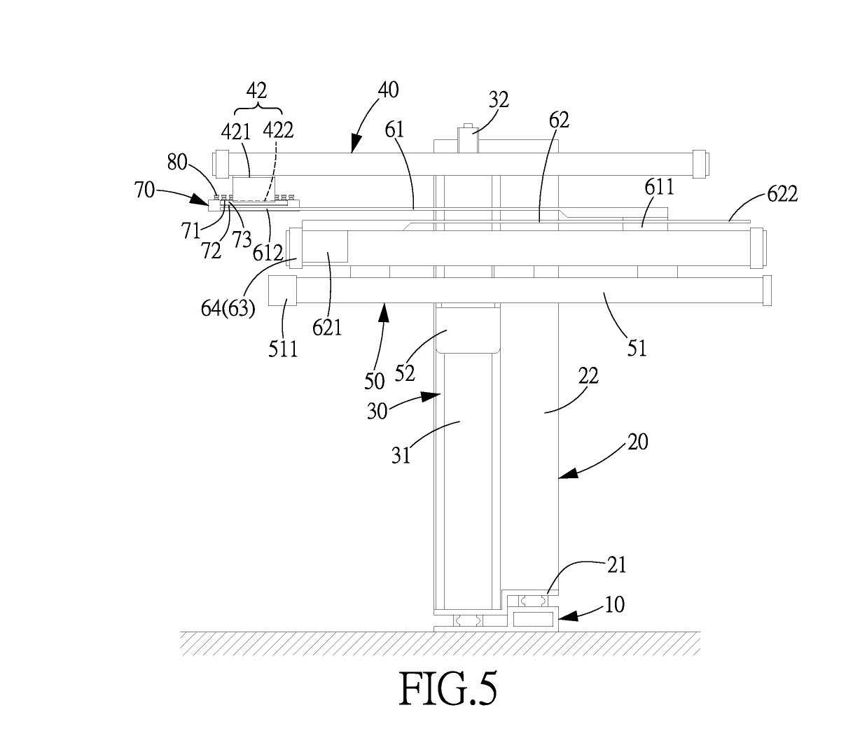

The following description illustrates how the rail transportation means of the present invention picks up a feeding tray 70 from the filling area A and moves it to the lyophilizer B. Please refer to FIG. 4, the control unit 22 of the slide block 20 drives the base portion 21 to move along the rail 10 to the filling area A. in this embodiment, the first picking member 61 of the material loading-and-unloading mechanism 60 is driven by the first and second movable guideways 30, 50 to move the two inserting members 612 of the first picking member 61 to the bottom of the lower ribs 72 of the feeding tray 70, then push the feeding tray 70 upward to a height in the second direction Y where the slots 73 of the feeding tray 70 are at the same level as the hook ends 422 of the hook member 42 of the position-switch device 40, and then the first picking member 61 is driven to move in the third direction Z until the hook ends 422 of the hook member 42 are received in the slots 73 of the feeding tray 70, and then the first movable guideway 30 drives the second movable guideway 50 to move in the second direction Y, and simultaneously drives the inserting members 612 of the first picking member 61 to move away from the lower ribs 72 of the feeding tray 70, so that the feeding tray 70 is hooked, in a suspended manner, by the hook member 42, as shown in FIG. 5.

After that, the third movable guideway 41 of the position-switch device 40 drives the hook member 42 to move the feeding tray 70 to a position above the inserting members 622 of the second picking member 62, then the second picking member 62 is moved by the first and second movable guideways 30, 50 to a position where the inserting members 622 are supported against the bottom of the lower ribs 72 of the feeding tray 70, so that the upper ribs 71 of the feeding tray 70 are disengaged from the hook ends 422 of the hook member 42 and supported, in a suspended manner, by the second picking member 62. The second picking member 62 moves in the third direction Z to make the feeding tray 70 disengage from the hook ends 422 of the hook member 42, and then are lowered and moved by the first and second movable guideways 30, 50 to a retracted position. So far, the operation of switching the feeding tray 70 from the first picking member 61 to the second picking member 62 is finished.

Finally, the trail transportation means moves along the rail 10 to send the feeding tray 70 to the lyophilizer B, the second picking member 62 extends into the lyophilizer B to horizontally place the feeding tray 70 on the shelf B 1, then the first and second movable guideways 30, 50 lowers a little to make the inserting members 622 move away from the bottom of the lower ribs 72 of the feeding tray 70, and then the second picking member 62 retracts back to leave the feeding tray 70 on the shelf B1 of the lyophilizer B, so that the feeding tray 70 is automatically moved from the filling area A to the lyophilizer B, without manual intervention.

During the bottled preparation manufacturing process, other feeding trays 70 are also moved by repeating the abovementioned operation that the first or second picking member 61, 62 of the material loading-and-unloading mechanism 60 are moved by the first and second movable guideways 30, 50 to make the inserting members 612, 622 support against the bottom of the lower ribs 72 of the feeding tray 70, then the feeding tray 70 is placed on or removed from the hook member 42 by the picking members 61, 62 and finally moved to the shelf C1 of the sealing device C. Moving the feeding tray 70 from the first picking member 61 to the second picking member 62 with the hook member 42 of the position-switch device 40 enables the rail transportation means of the present invention to transport material automatically without manual intervention, allowing the bottled preparation manufacturing process to be carried out in a dust-free and sterile environment, increasing product yield and production efficiency.

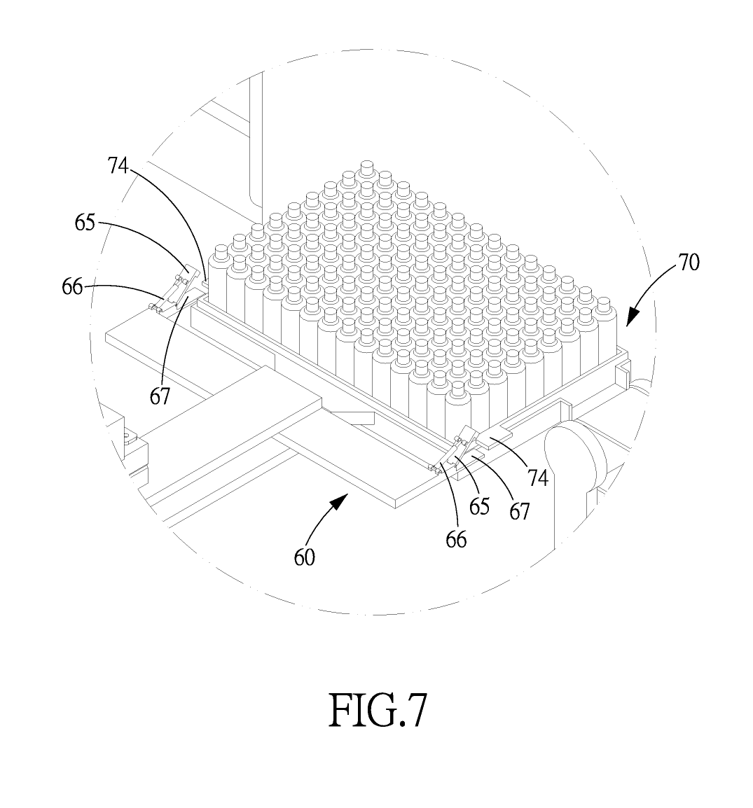

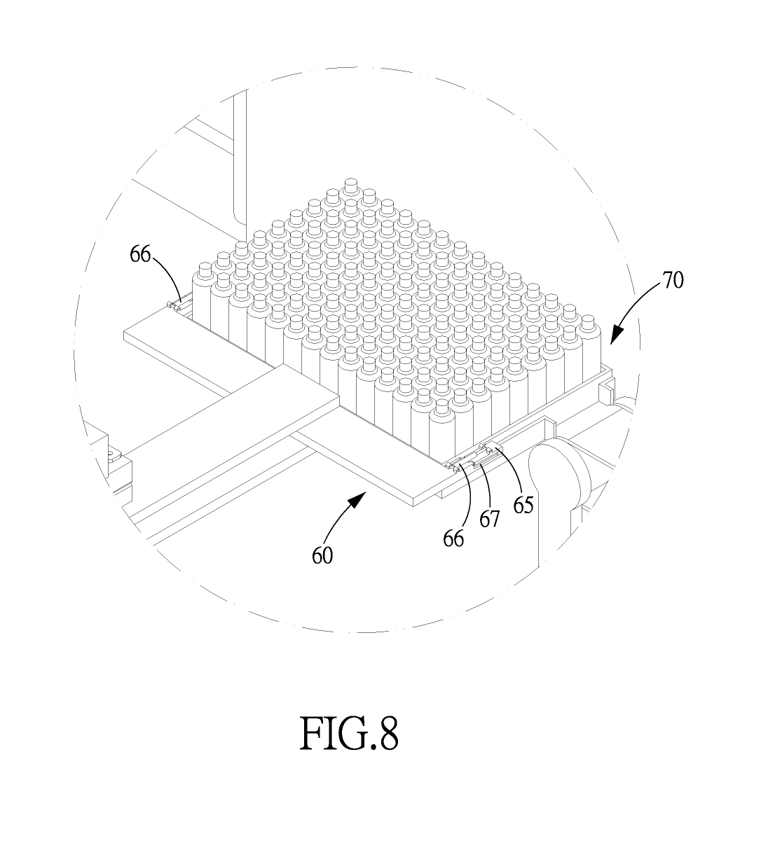

Referring then to FIGS. 7 and 8, another embodiment of the material loading-and-unloading mechanism 60 and the feeding tray 70 is shown, wherein the material loading-and-unloading mechanism 60 is provided with a pair of clamping members 65, and the feeding tray 70 is correspondingly provided with a pair of clamping portions 74. The clamping of the clamping members 65 is controlled by two pressure cylinders 66, and each of the clamping members 65 is provided with an abutting portion 67, so that the clamping portions 74 of the feeding tray 70 are against the abutting portions 67 when clamped by the clamping members 65. This embodiment also enables the rail transportation means of the present invention to transport material automatically without manual intervention, allowing the bottled preparation manufacturing process to be carried out in a dust-free and sterile environment, increasing product yield and production efficiency.

While we have shown and described various embodiments in accordance with the present invention, it is clear to those skilled in the art that further embodiments may be made without departing from the scope of the present invention.

What is claimed is:

1. A rail transportation means used in bottled preparation manufacturing process to transport a feeding tray, comprising:
a rail extending in a first direction;
a slide block including a base portion slidably mounted on the rail and a control unit mounted on the base portion, the base portion being controlled by the control unit to move on the rail along the X direction;
a first movable guideway including a first guideway which is mounted on the base portion of the slide block and perpendicular to the first direction, and a first power source provided at one end of the first guideway, a direction in which the first guideway moves being defined as a second direction;
a second movable guideway including a second guideway which is disposed at one side of the first guideway and perpendicular to the first and second directions, a drive member connected between the first and second guideways, and a second power source disposed at one end of the second guideway, a direction along which the second guideway extends being defined as a third direction, the second guideway and the drive member being driven by the first guideway to move along the second direction, and the second guideway being driven by the second power source to move in the third direction;
a material loading-and-unloading mechanism including a first picking member and a second picking member which are disposed on the second guideway in a superimposed manner, at one end of each of the first and second picking members being formed a drive portion, another end of each of the first and second picking members being provided with two inserting members to insert in a feeding tray, and the inserting members of the first and second picking members being located opposite to each other, the first and second picking members being driven by their respective power sources to move oppositely along the third direction; and
a position-switch device including a third movable guideway mounted on a top of the first movable guideway and extending in the third direction, and a hook member which has a connecting portion coupled to and driven by the third movable guideway to move along the third direction, the connecting portion extending in the first direction and having two hook ends to hook the feeding tray for enabling the first and second picking members to pick up the feeding tray by inserting the inserting members into the feeding tray.

2. The rail transportation means used in bottled preparation manufacturing process as claimed in claim 1, wherein the feeding tray is provided at each of two opposite sides thereof with an upper rib and a lower rib which are parallel to each other and define therebetween a slot, so that the hook ends of the hook member can be inserted in the slot to hook the feeding tray, making the feeding tray move between the inserting members of the first and second picking members, the first and second picking members of the material loading-and-unloading mechanism are moved by the first and second movable guideways to a position where the inserting members are supported against a bottom of the lower ribs of the feeding tray, then the feeding tray is placed on or removed from the hook member by the first and second picking members and finally moved to equipments involved in the manufacturing process.

3. The rail transportation means used in bottled preparation manufacturing process as claimed in claim 1, wherein a filling area is disposed at one side of the rail, and at another side of the rail is provided another lyophilizer, a sealing device and a final-product storage area.

4. The rail transportation means used in bottled preparation manufacturing process as claimed in claim 1, wherein a lyophilizer is disposed at each of two opposite sides of the rail, and the two lyophilizers are located at two opposite ends of the rail.

5. The rail transportation means used in bottled preparation manufacturing process as claimed in claim 1, wherein the material loading-and-unloading mechanism is provided with a pair of clamping members, the feeding tray is correspondingly provided with a pair of clamping portions, and clamping operation of the clamping members is controlled by two pressure cylinders.

6. The rail transportation means used in bottled preparation manufacturing process as claimed in claim 6, wherein each of the clamping members is provided with an abutting portion, so that the clamping portions of the feeding tray are against the abutting portions when clamped by the clamping members.
